(19) United States
(12) Patent Application Publication
(10) Pub. No.: US 2025/0190253 A1
(43) Pub. Date: Jun. 12, 2025

(54) MULTICORE LIFESPAN MANAGEMENT USING EXTRANEOUS CORES

(71) Applicant: Advanced Micro Devices, Inc., Santa Clara, CA (US)

(72) Inventors: Srilatha Manne, Bellevue, WA (US); Madhu Saravana Sibi Govindan, Austin, TX (US)

(73) Assignee: Advanced Micro Devices, Inc., Santa Clara, CA (US)

(21) Appl. No.: 18/332,819

(22) Filed: Jun. 12, 2023

(51) Int. Cl. G06F 9/48; G06F 15/80

(52) U.S. Cl. CPC G06F 9/4893; G06F 9/5094; G06F 15/80

(57) ABSTRACT

The disclosed device includes multiple physical processor cores including enabled cores and disabled cores. The device also includes a controller that can track a total aging value for each core and facilitate swapping out enabled cores for disabled cores to manage core lifespans. Various other methods, systems, and computer-readable media are also disclosed.

### BACKGROUND

When manufacturing multi-core systems, extraneous cores are often manufactured. The extraneous cores can be used, in some cases, for replacing faulty cores. However, even accounting for faulty cores, additional extraneous cores can remain. For example, a customer can request a system with a limited number of cores that is fewer than a manufacturer's design. Rather than redesigning the system with the reduced number of cores, which can be an expensive and extensive process, the manufacturer can produce the system and disable the extraneous cores to meet the customer's request.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary system for extending core lifespans by tracking enabled and disabled cores.

FIG. 2 is a diagram of an exemplary multi-core system having extra cores.

FIG. 3 is a diagram of an exemplary scheduling of enabled and disabled cores.

FIG. 4 is a flow diagram of an exemplary method for extending core lifespans by tracking and switching between enabled and disabled cores.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to managing core lifespans. As will be explained in greater detail below, implementations of the present disclosure track total aging values of physical processor cores, whether enabled or disabled. Enabled cores can be swapped for disabled cores based on respective aging values in order to prolong lifespans of the cores by distributing processor usage. In addition, processor cores that would otherwise remain unused can be used to prolong the lifespans of other processor cores normally used.

In one implementation, a device for extending core lifespans includes a plurality of physical processor cores including at least one enabled core and at least one disabled core, and a controller configured to track, for each of the plurality of physical processor cores, a total aging value.

In some examples, the total aging value corresponds to at least one of a total length of time a core has been enabled for a lifetime of the core, a total length of time the core has been active for the lifetime of the core, an activity level of the core while the core is active, or a system temperature while the core is active. In some examples, the controller is configured to continue tracking the total aging value for disabled cores of the plurality of physical processor cores after disabling the disabled cores.

In some examples, the controller is configured to swap out enabled cores for disabled cores. In some examples, the controller is further configured to swap out the enabled cores for the disabled cores by: (i) disabling, via power gating, one or more enabled cores, (ii) enabling, via a wake up operation, a number of disabled cores that corresponds to a number of the disabled one or more enabled cores, and (iii) logically remapping the disabled one or more enabled cores to the enabled one or more disabled cores.

In some examples, the controller swaps out the enabled cores for the disabled cores based on respective total aging values. In some examples, the controller swaps out the enabled cores for the disabled cores using a round-robin scheduling for the respective total aging values. In some examples, swapping the enabled cores for the disabled cores is invisible to an operating system.

In some examples, the controller is configured to periodically swap out the enabled cores for the disabled cores. In some examples, the periodic swapping is based on the enabled cores reaching an aging milestone. In some examples, the periodic swapping is based on a device reboot.

In one implementation, a system for extending core lifespans includes a physical memory, a plurality of physical processor cores comprising a first core that is enabled and a second core that is disabled. The system also includes a controller configured to track, for each of the plurality of physical processor cores, a total aging value, and swap out the first core for the second core based on the respective total aging values.

In some examples, the total aging value corresponds to at least one of a total length of time a core has been enabled for a lifetime of the core, a total length of time the core has been active for the lifetime of the core, an activity level of the core while the core is active, or a system temperature while the core is active. In some examples, the controller is further configured to swap out the first core for the second core by (i) disabling, via power gating, the first core, (ii) enabling, via a wake up operation, the second core, and (iii) logically remapping the disabled first core to the enabled second core.

In some examples, the controller is configured to swap out enabled cores for disabled cores using a round-robin scheduling for the respective total aging values. In some examples, the controller is configured to periodically swap out enabled cores for disabled cores. In some examples, the periodic swapping is based on at least one of the enabled cores reaching an aging milestone or a system reboot.

In one example, a method for extending core lifespans includes (i) tracking a total aging value for each of a plurality of physical processor cores, wherein the plurality of physical processor cores includes at least one enabled core and at least one disabled core, (ii) selecting the at least one enabled core and the at least one disabled core for swapping based on the respective total aging values, and (iii) swapping out the selected at least one enabled core for the selected at least one disabled core.

In some examples, swapping out the selected at least one enabled core for the selected at least one disabled core includes (a) disabling, via power gating, the selected at least one enabled core, (b) enabling, via a wake up operation, the selected at least one disabled core corresponding to a number of the disabled selected at least one enabled core, and (c) logically remapping the disabled selected at least one enabled core to the enabled selected at least one disabled core.

In some examples, the method further includes using a round-robin scheduling for selecting the at least one enabled core and the at least one disabled core for swapping

Features from any of the implementations described herein can be used in combination with one another in accordance with the general principles described herein. These and other implementations, features, and advantages will be more fully understood upon reading the following detailed description in conjunction with the accompanying drawings and claims.

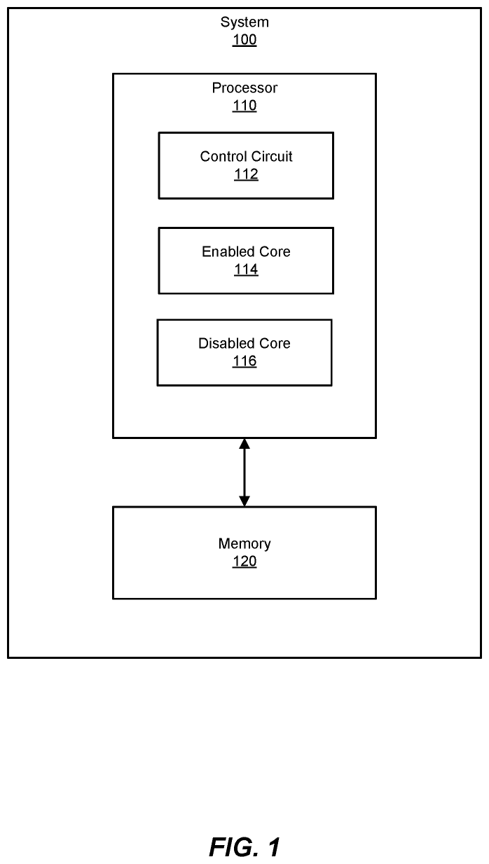

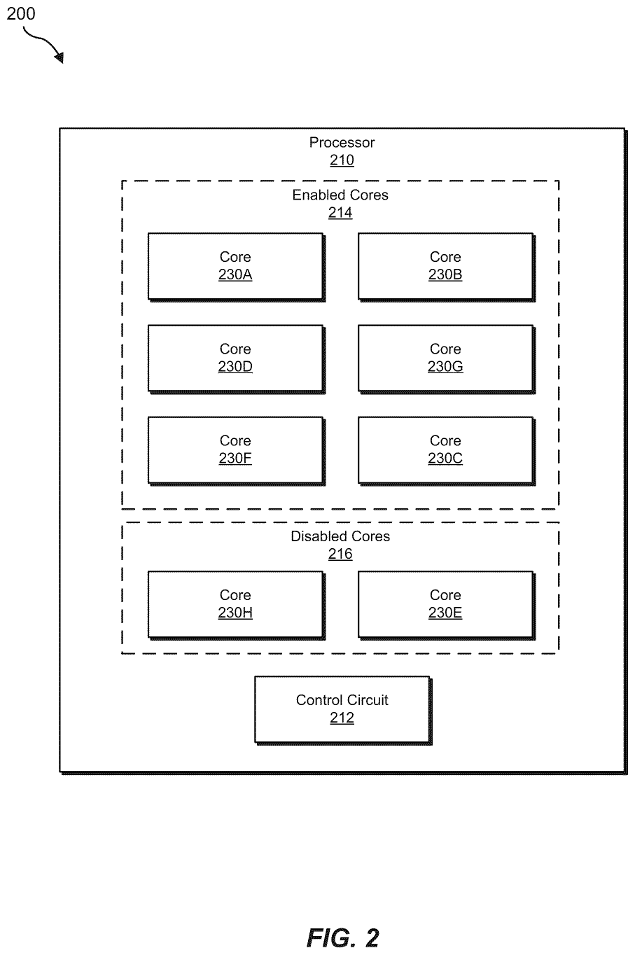

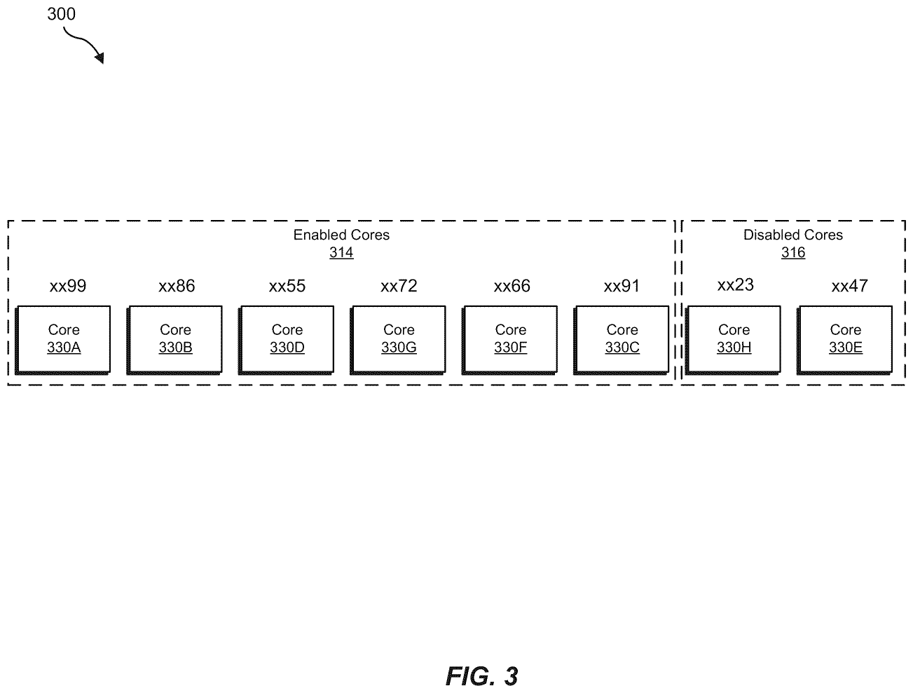

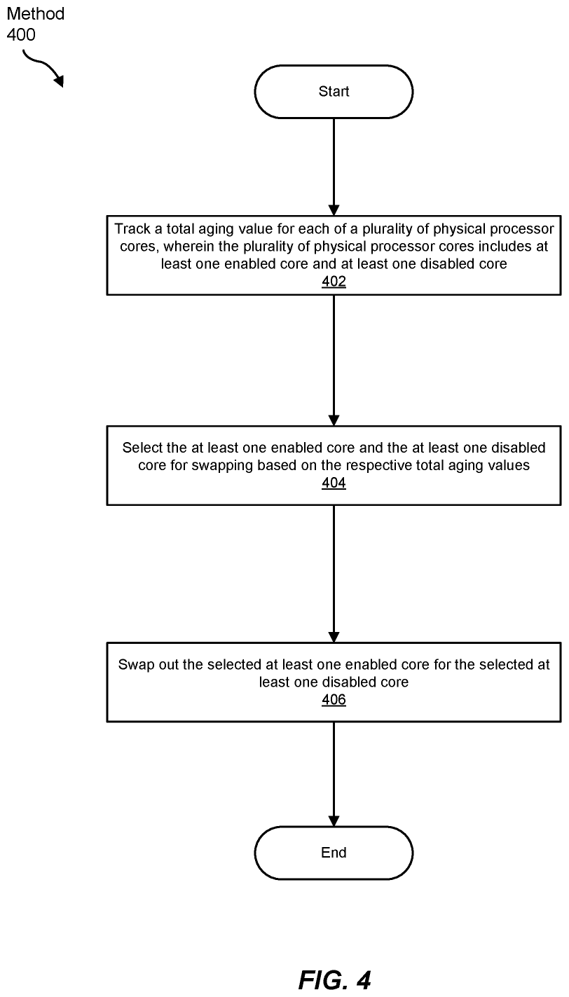

The following will provide, with reference to FIGS. 1-4, detailed descriptions of managing processor cores for extending core lifespans. Detailed descriptions of example systems for extending core lifespans are provided in connection with FIGS. 1 and 2. Detailed descriptions of scheduling processor aging will be provided in connection with FIG. 3. Detailed descriptions of corresponding computer-implemented methods will also be provided in connection with FIG. 4.

FIG. 1 is a block diagram of an example system 100 for extending processor core lifespans. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110. Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, chiplets (e.g., smaller and in some examples more specialized processing units that can coordinate as a single chip), microprocessors, microcontrollers, Central Processing Units (CPUs), graphics processing units (GPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, graphics processing units (GPUs), portions of one or more of the same, variations or combinations of one or more of the same, and/or any other suitable physical processor.

As further illustrated in FIG. 1, processor 110 includes a control circuit 112, an enabled core 114, and a disabled core 116 each of which corresponding to physical processor cores. Control circuit 112 corresponds to a controller that can manage and track (e.g., by saving, monitoring, and maintaining/updating values) aging of cores, including enabled core 114 and disabled core 116, as well as facilitate swapping of cores (e.g., enabling/disabling cores, transferring data, etc.). Enabled core 114 corresponds to a physical core of processor 110 that is enabled (e.g., powered on, and logically mapped to be available for use by an operating system (OS) of system 100). Disabled core 116 corresponds to another physical core of processor 110 that is disabled (e.g., power gated or otherwise in an inactive power state, and not logically mapped such that it is unavailable for use by the OS).

FIG. 2 illustrates a system 200 that corresponds to system 100. System 200 includes a processor 210 that corresponds to processor 110 and a control circuit 212 that corresponds to control circuit 112. Processor 210 further includes enabled cores 214 that correspond to various instances of enabled core 114, and disabled cores 216 that correspond to various instances of disabled core 116. As illustrated in FIG. 2, enabled cores 214 include a core 230A, a core 230B, a core 230D, a core 230G, a core 230F, and a core 230C. As further illustrated in FIG. 2, disabled cores 216 include a core 230H and a core 230E.

Cores 230A-230H each correspond to a physical processing core that is functional. During a manufacturing process for a cluster of cores, extra or redundant cores are often produced beyond an intended number of cores. When testing the manufactured cores, faulty cores are physically disconnected (e.g., fused off) and replaced by redundant cores. Any remaining extraneous cores can be physically disconnected to meet the designated number of cores. However, in some cases, a customer may request fewer cores, for instance in latency-sensitive cases in which a greater number of cores can create bandwidth and contention issues between the cores. In such cases, rather than redesigning an architecture for fewer cores, an existing architecture can be used, with extraneous cores being physically disconnected. However, in such cases, several viable cores will be unused.

The systems and methods described herein allow usage and management of extraneous cores while maintaining desired restraints on a number of processing cores. Accordingly, enabled cores 214 can correspond to a number of desired cores and disabled cores 216 can correspond to a number of extraneous (and functional) cores. However, rather than physically disconnecting the extraneous cores, in system 200 the extraneous cores are logically disconnected.

In some examples, a software (e.g., firmware, BIOS, kernel, OS, etc.) can logically connect and/or disconnect cores. For instance, each of enabled cores 214 can be logically mapped such that each of enabled cores 214 are visible to the OS and available for performing processing tasks. Conversely, each of disabled cores 216 are not logically mapped such that each of disabled cores 216 are not visible to the OS nor available for performing processing tasks. In addition, to reduce power consumption, each of disabled cores 216 can be power gated or otherwise place in an inactive power state.

Because disabled cores 216 are logically disconnected rather than physically disconnected, each of disabled cores 216 can be logically connected and used. As described herein, control circuit 212 can facilitate logically connected one or more of disabled cores 216, which can include a wake up operation and a logical mapping. In some implementations, to maintain the designated number of cores, control circuit 212 can facilitate swapping out one of enabled cores 214 for one of disabled cores 216. For instance, swapping out core 230A for core 230H can include disabling core 230A via power gating and enabling core 230H via a wake up operation. Additionally, control circuit 212 can facilitate (e.g., in conjunction with software) logically remapping core 230A to core 230H such that logically, the core appears unchanged to the OS. In some examples, swapping out cores can be invisible to the OS. By logically remapping core 230A to core 230H, the OS can continue operating (e.g., based on the logical designation of cores) fully unaware of and materially unaffected by the physically different core for the logical designation. For instance, the OS can use a logical core, and continue using the logical core, without being alerted to, made aware of, having to actively respond to, or otherwise reacting to a change of the physical core mapped to this logical core while the OS uses this logical core. Moreover, the swapping of cores can occur independently from OS operations.

As enabled cores 214 are used, they each degrade (e.g., due to thermal warping, breaking down of materials, etc.). Accordingly, control circuit 212 can, for each core, track a total aging value corresponding to one or more of a total length of time and/or depth of utilization over time a core has been enabled for a lifetime of the core, a total length of time the core has been active for the lifetime of the core, an activity level of the core while the core is active, or a system temperature while the core is active. Control circuit 212 can, in some examples, track a value by storing the value, such as by storing one or more bits in one or more registers or other storage device incorporated with or interfacing with control circuit 212, and by monitoring (e.g., periodically and/or continuously) related metrics, control circuit 212 can update and/or maintain the stored value as needed. In some examples, the total aging value can correspond to a combination of characteristics, such as total length of time the core has been enabled, enabled and active, enabled and active along with the activity level while active, enabled and active along with the activity level and the system temperature, etc. Such combinations of characteristics can more accurately track core aging, for instance a core that is enabled and power gated would age at a different rate as a core that is enabled and 100% active while enabled. Because each of disabled cores 216 can be enabled, control circuit 212 tracks a total aging value for each functional core (e.g., each of enabled cores 214 and each of disabled cores 216) whether the core is enabled or disabled. Thus, control circuit 212 can track aging values, which can be tracked in any appropriate unit such as time, cycles, instructions per cycle (IPC) while running, usage level of cores, depth of utilization, remaining life, etc., for each usable core for processor 210.

To prolong a lifespan of each processing core by distributing aging, control circuit 212 can facilitate swapping out cores (e.g., between enabled cores 214 and disabled cores 216) based on their respective total aging values. For example, control circuit 212 can select an oldest or most aged core from enabled cores 214 and swap it out for the youngest or least aged core from disabled cores 216. As a number of cores grows, control circuit 212 can use various scheduling schemes to manage core lifespans.

FIG. 3 illustrates a diagram 300 of enabled cores 314 corresponding to enabled cores 214 and disabled cores 316 corresponding to disabled cores 216. Each of core 330A, core 330B, core 330C, core 330D, core 330E, core 330F, core 330G, and core 330H can correspond to cores 230A-230H, respectively, and also each correspond to separate instances of processor cores (e.g., enabled core 114 and/or disabled core 116) which are functional, whether enabled or disabled. A controller (e.g., control circuit 212 and/or control circuit 112) can manage cores 330A-330H, for example by monitoring a respective aging of each core and swapping out or facilitate swapping out one or more of enabled cores 314 and disabled cores 316 to manage core aging.

As illustrated in FIG. 3, each of cores 330A-330H have respective total aging values (illustrated above each core in FIG. 3). As described herein, the controller can manage swapping out one or more of enabled cores 314 for a same number of disabled cores 316 to distribute aging amongst cores 330A-330H while maintaining a designated number of enabled cores 314. The numbers shown in FIG. 3 can correspond to any appropriate unit for tracking aging, such as time units, cycles, instructions per cycle (IPC) while running, usage level of cores, depth of utilization, remaining life, etc. For example, core 330A has been enabled for 99 units, core 330B has been enabled for 86 units, and so forth. In some examples, the controller can select one of enabled cores 314 based on one or more of enabled cores 314 reaching an aging milestone. In some examples, the aging milestone can be a predetermined number (e.g., core 330A reaching 100), and in other examples, the aging milestone can be relative (e.g., core 330A reaching a double age of a youngest core, etc.).

In some examples, the controller can use a round-robin scheduling for swapping out one or more of enabled cores 314 for one or more of disabled cores 316 based on respective total aging values. For example, after a period of time elapses (e.g., a predetermined and/or dynamically selected period of aging, which can be global to enabled cores 314 and/or relative to particular cores), the controller can select one or more of enabled cores 314 for swapping out with a same number of disabled cores 316. For example in FIG. 3, the controller can select core 330A and core 330C (being the oldest at 99 and 91 units aged, respectively) for core 330H and core 330E.

In some examples, the controller can select as many of enabled cores 314 as there are disabled cores 316 available for swapping. In other examples, the controller can select, from enabled cores 314, up to the number of disabled cores 316. The controller can select cores from enabled cores 314 that have aged for the period of time, and further based on oldest. In some examples, the controller can further select based on frequency and/or number of times a core has been swapped. Moreover, the controller can select cores to ensure that a younger core is not swapped out for an older core.

Swapping out cores can, in some examples, incur overhead, such as enabling (e.g., waking up) and disabling (e.g., power gating) cores, logically remapping cores and associated software context switching, as well as processor overhead of refilling caches and instruction pipelines, etc. To prevent this overhead during periods of high activity, in some examples the controller can periodically swap out cores. For instance, the controller can wait for a period of low activity or a period when the overhead does not significantly impact performance, such as during a device or system reboot.

FIG. 4 is a flow diagram of an exemplary method 400 for managing cores for extending core lifespans. The steps shown in FIG. 4 can be performed by any suitable circuit, computer-executable code and/or computing system, including the system(s) illustrated in FIGS. 1 and/or 2. In one example, each of the steps shown in FIG. 4 represent an algorithm whose structure includes and/or is represented by multiple sub-steps, examples of which will be provided in greater detail below.

As illustrated in FIG. 4, at step 402 one or more of the systems described herein track a total aging value for each of a plurality of physical processor cores. The plurality of physical processor cores includes at least one enabled core and at least one disabled core. For example, control circuit 112 can track total aging values of enabled core 114 and disabled core 116.

At step 404 one or more of the systems described herein select the at least one enabled core and the at least one disabled core for swapping based on the respective total aging values. For example, control circuit 112 can select enabled core 114 and disabled core 116 based on their respective total aging values.

At step 406 one or more of the systems described herein swap out the selected at least one enabled core for the selected at least one disabled core. For example, control circuit 112 can swap out disabled core 116 for enabled core 114.

The systems described herein can perform step 406 in a variety of ways. In one example, control circuit 112 can swap out the selected enabled core for the selected disabled core by disabling, via power gating, the selected enabled core and enabling, via a wake up operation, the selected disabled core. A number of cores selected and enabled via the wake up operation can correspond to a number of the cores that are disabled via power gating. Control circuit 112 can complete the swap by logically remapping the disabled selected at least one enabled core to the enabled selected at least one disabled core.

In some examples, control circuit 112 can manage when to perform swapping. For example, control circuit 112 can use a round-robin scheduling for selecting the at least one enabled core and the at least one disabled core for swapping.

As detailed above, the systems and methods described herein can address the problem of marginal faults by detecting the occurrence of faults (e.g., by using two cores to run the same code and check the results against each other), reducing the occurrence of faults (e.g., by rotating through cores), and/or replacing faulty cores on premise without requiring significant efforts from a user/customer. Marginal faults are a growing problem in computing and will continue to be an inherent problem given the size of the chips, the ever-shrinking process technologies, and the myriad of corner cases that could occur once ambient temperatures and data inputs are considered. The marginal faults are exposed once a set of unique events occur, and hence can be difficult to detect and eliminate completely at manufacturing stages.

In some cases, there are more cores than necessary that meet customer requirements, for instance high frequency trading where there is little tolerance for latency variation. In other examples, customers may want to optimize Total Cost of Ownership (TCO). For example, if the customer requires 2 cores per core complex, and there are 4 viable cores in the complex, the viable cores are still fused off.

In describing cores, there can be faulty cores that are not viable for the customer requirements and are normally fused off, extraneous cores that are healthy and viable but are not necessary to meet requirements and are also normally fused off and delivered cores that are delivered to the customer for use in their products.

As detailed above, in the systems and methods described herein the extraneous cores are not fused off but are utilized to detect marginal faults, reduce the likelihood of marginal faults resulting from aging and use, and/or provide a mechanism to fix parts in the field. This can advantageously result in better silicon behavior (i.e., reduction in silent data corruption) and longer lasting parts. In some implementations, the extraneous cores can be managed by the OS or Hypervisor stack in the following manner.

For detecting marginal faults, the extraneous cores can be utilized for redundancy to check for silent data corruption or marginal faults. Out-of-production testing can be extensive but is cumbersome as it normally requires the tested system to be out of production. In-production testing is less invasive and does not require the tested system to be out of production, by co-locating the normal workload with test instructions, but is limited in scope given the short test duration. However, the systems and methods described herein allow using the extraneous cores such that both out-of-production and in-production testing can be performed without taking the tested system out of production. For example, the normal workload can be temporarily housed in the extraneous cores while the delivered cores are tested. Once testing is complete, the workload is moved back to the delivered cores and the extraneous cores can continue being unused.

For reducing aging related faults (e.g., prolonging core lifespans as described above), the system can switch between the delivered cores and the extraneous cores in order to reduce the impact of aging on the cores. In some implementations, at any moment in time, the customer only has access to the cores they purchased (e.g., the number of delivered cores). However, the physical core being used can be either one of the delivered or extraneous cores and the cores can be switched in a round-robin manner or other appropriate scheme. Switching between cores can be accomplished in several different ways by hardware and/or software. For example, a software orientated management can include isolating (e.g., by the operating system (OS)) a set of physical cores from the kernel process scheduler. These isolated CPUs are not considered by the scheduler when scheduling user-level processes or kernel threads that are not pinned to one of the isolated CPUs. The only way a thread can get onto or off the isolated CPUs is via scheduler affinity calls and utilities. This mechanism can be extended/modified to support different switching schemes between delivered and extraneous cores. Further, in some implementations an OS thread or daemon could keep track of how long each core has been in active use. Once a pre-determined threshold of activity is reached, the current set of physical cores (currently designated as delivered) can be isolated from the scheduler, and the set of physical cores currently designated as extraneous cores can be brought back as the delivered cores.

In another implementation, switching between delivered and extraneous cores can be performed via core offlining/onlining provided by the OS kernel. Similar to the isolating idea, once a configurable threshold of core usage is reached, the kernel thread or daemon can take the current active cores offline, and bring the offline, extraneous cores online. The thresholds of activity could be configurable as per the customer requirements, reliability constraints, as well as the downtime that the customer workloads can tolerate.

In some implementations, the mechanisms to switch between the delivered and extraneous cores can preferably be invisible to the end customers in many cases, and can require, in some examples, support from the software stack-hypervisor, OS and possibly, the platform firmware. Although the examples described herein include the hypervisor as deciding core switching, in other examples any system software can manage core switching. One such mechanism could be implemented as a logical-to-physical core mapping table implemented by the hypervisor. Using this mapping table, the hypervisor decides which physical cores are mapped to the logical/delivered cores at any point in time. Whenever the hypervisor decides to switch a new physical core as the logical core (based on many heuristics including reliability models, operating conditions, etc.), the hypervisor can take the currently-assigned physical core offline, and bring a new physical core online, and update its logical-to-physical core mapping table to reflect this change. Depending on the implementation, the platform firmware can be notified/involved. If the “old” physical core is left idle from the hypervisor standpoint, it would naturally enter the power-gated/sleep state, which should be transparent to the platform firmware. Because the hypervisor maintains this logical-to-physical core mapping table, the information about which physical core is assigned to a logical core can be invisible to the running applications and does not break features like users requesting affinity to specific logical cores.

Depending on the constraints, the switch between the delivered and extraneous cores can be performed one at a time rather than all of them together. The core downtimes when this switch is performed en masse can be prohibitive for the end customers, such that switching one logical core at a time can be practical in some cases. The usage tracking of how long each core has been in active use can be done, in some examples, within the OS, hypervisor, and/or platform firmware or some combination thereof.

Switching dynamically between delivered and extraneous cores can incur the overhead of switching the physical core corresponding to a logical core. Whenever this switch happens, the physical core will not be available for scheduling any process. The “old” physical core must be placed in the power-gated/idle state while the “new” physical core must be woken up from the power-gated state, which incurs extra latency in rescheduling a process running on the “old” physical core. Additionally, since the caches of the “new” physical core would be cold, there could be a cache miss penalty for the running application after the core switch. These factors could result in a small loss in application performance. However, the time constant in which the hypervisor/OS will be performing the switch of physical cores can be in the order of several days or several hours. Due to these large time constants involved in the frequency of switching the cores, the performance losses caused by these switches can therefore be negligible and not visible to the end customers. Moreover, managing when core switches occur as described herein can further mitigate such performance losses.

In another use case, use of the extraneous cores can be reserved to when there are faults detected or predicted on the delivered cores (e.g., for in-situ repair). Every core has many CPO (critical path optimizers) that can be used to predict the likelihood of failure due to device marginality combined with aging and operating conditions (i.e., high temperature or high di/dt noise). When the delivered core is manifesting suspect behavior, or predicted to be wearing out, the delivered core can be replaced with one of the extraneous cores. With a good predictor for determining when the current core can be replaced with one of the extraneous cores, the replacement can take place at an opportune time when the application in question will not be impacted by the change and before the part fully fails.

As detailed above, the circuits, computing devices and systems described and/or illustrated herein broadly represent any type or form of computing device or system capable of executing computer-readable instructions, such as those contained within the modules described herein. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the modules and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), systems on a chip (SoCs), digital signal processors (DSPs), Neural Network Engines (NNEs), accelerators, graphics processing units (GPUs), portions of one or more of the same, variations or combinations of one or more of the same, or any other suitable physical processor.

Although illustrated as separate elements, the modules described and/or illustrated herein can represent portions of a single module or application. In addition, in certain implementations one or more of these modules can represent one or more software applications or programs that, when executed by a computing device, cause the computing device to perform one or more tasks. For example, one or more of the modules described and/or illustrated herein represent modules stored and configured to run on one or more of the computing devices or systems described and/or illustrated herein. In some implementations, a module can be implemented as a circuit or circuitry. One or more of these modules can also represent all or portions of one or more special-purpose computers configured to perform one or more tasks.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A device comprising:
a plurality of physical processor cores comprising at least one enabled core, and at least one disabled core that is logically disconnected; and
a controller configured to track, for each of the plurality of physical processor cores, a total aging value.

2. The device of claim 1, wherein the total aging value corresponds to at least one of:
a total length of time a core has been enabled for a lifetime of the core;
a total length of time the core has been active for the lifetime of the core;
an activity level of the core while the core is active; or
a system temperature while the core is active.

3. The device of claim 1, wherein the controller is configured to continue tracking the total aging value for disabled cores of the plurality of physical processor cores after disabling the disabled cores.

4. The device of claim 1, wherein the controller is configured to swap out enabled cores for disabled cores.

5. The device of claim 4, wherein the controller is further configured to swap out the enabled cores for the disabled cores by:
disabling, via power gating, one or more enabled cores;
enabling, via a wake up operation, a number of disabled cores that corresponds to a number of the disabled one or more enabled cores;
logically remapping the disabled one or more enabled cores to the enabled one or more disabled cores; and
logically disconnecting the disabled one or more enabled cores such that the disabled one or more enabled cores are not logically mapped, are not visible to an operating system, and are unavailable for performing processing tasks.

6. The device of claim 4, wherein the controller swaps out the enabled cores for the disabled cores based on respective total aging values.

7. The device of claim 6, wherein the controller swaps out the enabled cores for the disabled cores using a round-robin scheduling for the respective total aging values.

8. The device of claim 4, wherein swapping the enabled cores for the disabled cores is invisible to an operating system.

9. The device of claim 4, wherein the controller is configured to periodically swap out the enabled cores for the disabled cores.

10. The device of claim 9, wherein the periodic swapping is based on the enabled cores reaching an aging milestone.

11. The device of claim 9, wherein the periodic swapping is based on a device reboot.

12. A system comprising:
a physical memory;
a plurality of physical processor cores comprising:
a first core that is enabled; and
a second core that is disabled such that the second core is logically disconnected; and
a controller configured to:
track, for each of the plurality of physical processor cores, a total aging value; and
swap out the first core for the second core based on the respective total aging values.

13. The system of claim 12, wherein the total aging value corresponds to at least one of:
a total length of time a core has been enabled for a lifetime of the core;
a total length of time the core has been active for the lifetime of the core;
an activity level of the core while the core is active; or
a system temperature while the core is active.

14. The system of claim 12, wherein the controller is further configured to swap out the first core for the second core by:
disabling, via power gating, the first core;
enabling, via a wake up operation, the second core;
logically remapping the disabled first core to the enabled second core; and
logically disconnecting the disabled first core such that the disabled first core is not logically mapped, is not visible to an operating system, and is unavailable for performing processing tasks.

15. The system of claim 12, wherein the controller is configured to swap out enabled cores for disabled cores using a round-robin scheduling for the respective total aging values.

16. The system of claim 12, wherein the controller is configured to periodically swap out enabled cores for disabled cores.

17. The system of claim 16, wherein the periodic swapping is based on at least one of the enabled cores reaching an aging milestone or a system reboot.

18. A method comprising:
tracking a total aging value for each of a plurality of physical processor cores, wherein the plurality of physical processor cores includes at least one enabled core, and at least one disabled core that is logically disconnected;
selecting the at least one enabled core and the at least one disabled core for swapping based on the respective total aging values; and
swapping out the selected at least one enabled core for the selected at least one disabled core.

19. The method of claim 18, wherein swapping out the selected at least one enabled core for the selected at least one disabled core comprises:
disabling, via power gating, the selected at least one enabled core;
enabling, via a wake up operation, the selected at least one disabled core corresponding to a number of the disabled selected at least one enabled core;
logically remapping the disabled selected at least one enabled core to the enabled selected at least one disabled core; and
logically disconnecting the disabled selected at least one enabled core such that the disabled selected at least one enabled core is not logically mapped, is not visible to an operating system, and is unavailable for performing processing tasks.

20. The method of claim 18, further comprising using a round-robin scheduling for selecting the at least one enabled core and the at least one disabled core for swapping.
